(19) United States
(12) Patent Application Publication
(10) Pub. No.: US 2001/0008499 A1
(43) Pub. Date: Jul. 19, 2001

(54) Transmitting and receiving apparatus

(76) Inventor: Siu Ling Ko, Kowloon (HK)

Correspondence Address: DARBY & DARBY P.C, 805 Third Avenue, New York, NY, 10022, US

(21) Appl. No.: 09/726,979

(22) Filed: Nov. 30, 2000

Related U.S. Application Data
(63) Continuation-in-part of application No. 09/483,688, filed on Jan. 14, 2000.

(51) Int. Cl. H04B 1/59

(52) U.S. Cl. 367/2

(57) ABSTRACT

Ultrasonic transmitting and receiving apparatus comprises a transmitter operable in response to a program to emit an ultrasonic signal and a receiver preprogrammed with a plurality of functions actuable in response to a said ultrasonic signal from the transmitter. The transmitter may comprise a PC 10 with a loudspeaker 18 and the receiver may comprise a stuffed toy 12 housing a microphone 14 and a microprocessor decoder and controller 16. Decoded signals may actuable motion, visual and audio functions of the toy.

This invention relates to transmitting and receiving apparatus comprising a transmitter capable of transmitting sound waves at an ultrasonic frequency and a receiver actuable to perform predetermined functions in response to such transmissions.

In accordance with the broadest aspect of the invention there is provided ultrasonic transmitting and receiving apparatus comprising a transmitter operable in response to a set of instructions to emit an ultrasonic signal at predetermined times in accordance with said instructions; and a receiver pre-programmed with a plurality of functions each of which is actuable in response to a said ultrasonic signal from said transmitter.

The transmitter is preferably also operable in response to said set of instructions to emit an audio signal. Said transmitter may comprise a computer, television or radio provided with a loudspeaker capable of emitting said ultrasonic signal and said audio signal.

Conveniently said transmitter comprises a computer and said set of instructions is contained in a program runnable in the computer, the computer being provided with a loudspeaker capable of emitting said ultrasonic signal at predetermined times during running of the programme and also being capable of emitting an audio signal. The programme when running in the computer may enable the computer to generate a visual display on a screen, a said ultrasonic signal and a said audio signal.

Said receiver preferably includes a microphone, a microprocessor decoder and controller and means whereby a said ultrasonic signal received by the microphone may be converted to an electronic signal and sent to the decoder to actuate a said function. Said functions may comprise audio and/or visual and/or motion functions. In an alternative embodiment, the ultrasonic signal generated in the PC can be transmitted to the decoder electronically without the speaker and microphone by using a cable attached to the output of the PC (or other transmission device) and input of the decoder (or other receiver device). Each of said pre-programmed functions is conveniently switchable between an on-and-off condition in response to a said ultrasonic signal from the transmitter or alternatively, one or more of the settings of a said pre-programmed function may be variable in response to a said ultrasonic signal from the transmitter.

Other features of the invention will become apparent from the following description given herein solely by way of example with reference to the accompanying drawings wherein

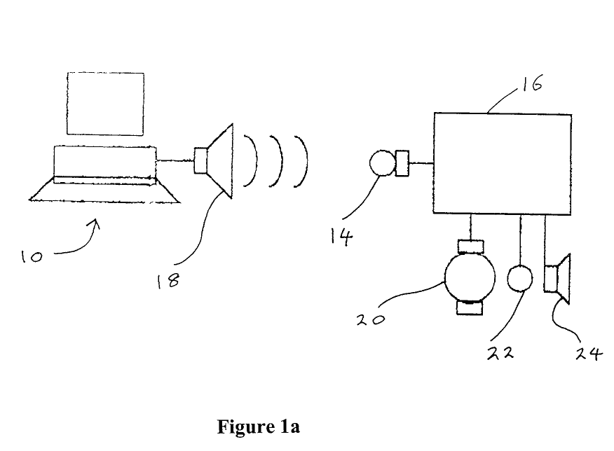

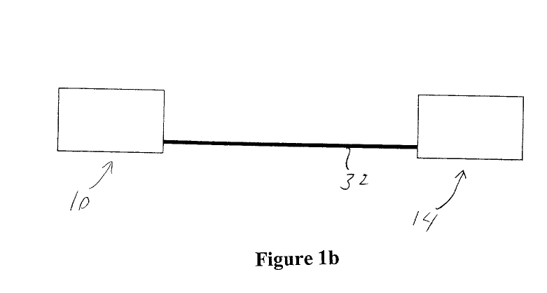

FIG. 1a is a diagrammatic representation of transmitting and receiving apparatus including a speaker and a microphone in accordance with the invention,

FIG. 1b is a diagrammatic representation of transmitting and receiving apparatus in which the speaker and microphone mode of transmission is replaced with a cable,

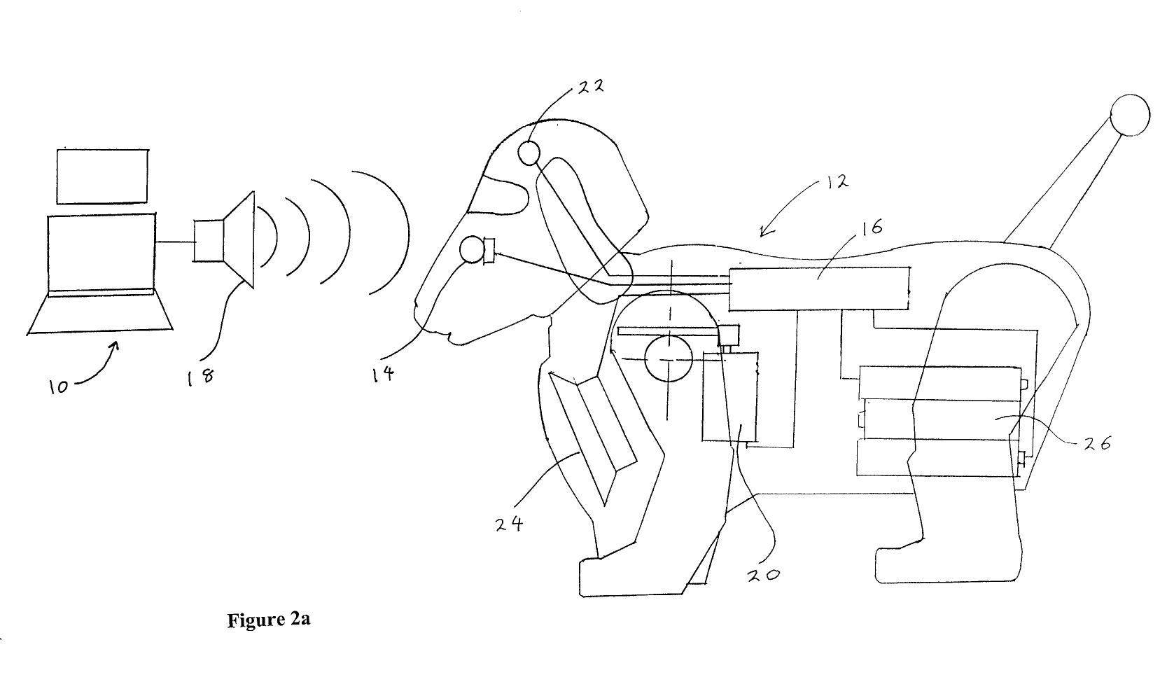

FIG. 2a is a diagrammatic representation similar to FIG. 1 showing the receiving apparatus in the form of a toy,

FIG. 2b is a diagrammatic representation similar to FIG. 1 showing the receiving apparatus in the form of a robot, and

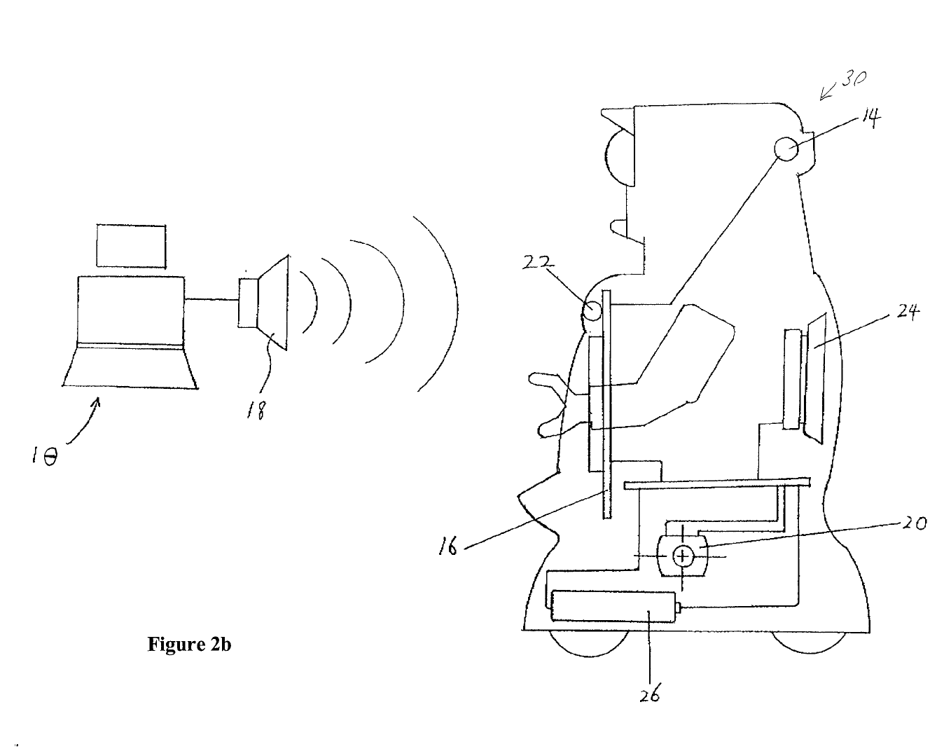

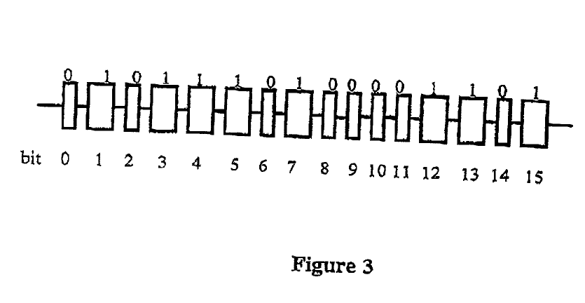

FIG. 3 is a diagrammatic representation of an ultrasonic tone burst of the type transmitted from the transmitter to the receiver.

One embodiment of transmitting and receiving apparatus constructed in accordance with the invention comprises the embodiment illustrated in the drawings comprising a personal computer (PC) 10 and a stuffed toy 12 housing a microphone 14, microprocessor decoder and controller 16 and means whereby an ultrasonic signal received by the microphone may be converted to an electronic signal and sent to the decoder to actuate an audio and/or visual and/or motion function.

The PC 10 is wired to a loudspeaker 18 capable of emitting signals in the audio and ultrasonic frequency ranges. The loudspeaker connection to the PC enables a set of instructions contained within a program runnable in the computer to transmit commands in the form of ultrasonic tone bursts at predetermined time intervals during the running of the program. The program may also generate visual images on the screen of the PC monitor and also generate audio signals at any time during running of the program. Thus in this embodiment the PC and loudspeaker connected thereto comprise the transmitter part of the transmitting and receiving apparatus.

The receiver part of the apparatus may comprise a stuffed toy 12 or a robot (for example, a stuffed toy robot) 30 as illustrated diagrammatically in FIGS. 2 and 4, respectively. The toy houses a microphone 14 which may be of a condenser type with a frequency coverage of up to 30 KHz. The toy also houses a microprocessor decoder and controller 16 conveniently comprising a PIC16C5X single chip microprocessor under the controller of a proprietary program. The microprocessor receives data transmitted from the PC 10 and loudspeaker 18 and microphone 14.

The toy 12 also houses a motor and gearing 20 for actuating motion functions, a light 22 for actuating visual functions and a voice synthesizer 24 for actuating audio functions. All of such functions as well as the microprocessor decoder and controller are powered by one or more batteries 26 housed within the toy 12. When a command is executed at the PC the program transmits the command in the form of ultrasonic tone bursts through the loudspeaker which are picked up by the microphone and converted to electronic signals and sent to the microprocessor decoder. The decoder than decodes the signal and drives the appropriate motion, visual or audio device.

The ultrasonic code comprises a series of width modulated tone bursts, each tone burst being separated by a short silence period. Each code consists of a total of 16 bursts with a wide burst representing the logic “1” and a short burst representing the logic “0”. A command may be represented by a single 16 bit code or multiple 16 bit codes. A typical command code “1011000010111010” is illustrated in FIG. 3 of the drawings.

Each of the functions of the toy is pre-programmed and may be actuable between an on-and-off condition in response to an ultrasonic command code or alternatively one or more of the settings of a said pre-programmed function may be variable in response to an ultrasonic command code. It will be appreciated that such codes are not detectable by the human ear and thus a user of the computer will only hear the audio signals generated by the program running in the computer. When the receiver is housed within a toy as described herein, the toy will appear to learn from the computer because it will respond only to the ultrasonic command codes which will not be detectable by the computer user. Once the toy has “learnt” the commands during the running of a computer program, the toy can subsequently be actuated to reproduce the “learnt” functions by means of a separate infra-red controller. In such an embodiment the toy will of course also include an infra-red signal detector appropriately connected to the microprocessor decoder and controller. Additionally or alternatively, the toy can be actuated to reproduce the “learnt” functions by means of a command picked up by the microphone 14.

The broadest form of the invention comprises a transmitter operable in response to a set of instructions to emit an ultrasonic signal at predetermined times in accordance with said instructions. Thus the transmitter need not comprise a PC loudspeaker and could comprise television or radio apparatus provided with a suitable loudspeaker capable of emitting the necessary ultrasonic signal and preferable also an audio signal. It will be appreciated that the apparatus of the invention will not necessitate modification of the hardware whether or not it comprises a computer, television or radio apparatus. The only requirement is that one or more loudspeakers are provided capable of emitting the necessary ultrasonic signal in addition to the normal audio frequency signal. All of the command codes for the receiver are contained within the program which can either be run on a PC or elsewhere and transmitted through a loudspeaker. When used with a PC, the program may be embodied in a floppy disk or a CD Rom or may be downloaded from the Internet.

In an alternative embodiment as shown in FIG. 1b, the ultrasonic signal generated in the PC 10 can be transmitted to the decoder 14 electronically without a speaker or microphone. Rather, a cable 32 (for example, a jumper cable) can be used so that the ultrasonic signal passes directly into the decoder 14 electronically, thereby ensuring error free transmission. More particularly, one end of the cable 32 feeds into the speaker output jack (not shown) of the PC and the other end of the cable 32 feeds into an input jack (not shown) of the decoder 14.

The program may have a typical running time of around 1 minute during which time the receiver housed in the toy could either react immediately to an ultrasonic signal or store a signal for subsequent actuation of a function. For example, a toy in the form of a dog could have a pre-programmed function switchable to its “on” condition upon reception of an ultrasonic signal so as immediately to cause the audio function to emit a barking sound. The toy dog could receive an ultrasonic signal and store the “on” instructions in its microprocessor memory to actuate a suitable function in response to a later command received from either an infra-red controller or via the microphone 14.

In a further example, a toy could have a pre-programmed function comprising a clock wherein one or more of the clock settings is variable in response to a said ultrasonic signal from the transmitter.

1. An ultrasonic transmitting and receiving apparatus comprising a transmitter operable in response to a set of instructions to generate an ultrasonic signal at predetermined times in accordance with said instructions; and a receiver pre-programmed with a plurality of functions each of which is actuable in response to a said ultrasonic signal from said transmitter.

2. The apparatus as claimed in claim 1 wherein said transmitter is also operable in response to said set of instructions to emit an audio signal.

3. The apparatus as claimed in claim 1 wherein said set of instructions is contained in a program runnable in a computer.

4. The apparatus as claimed in claim 1 wherein said transmitter comprises a computer, television or radio provided with one of a loudspeaker capable of emitting said ultrasonic signal and a connection to a cable for direct transmission of said ultrasonic signal.

5. The apparatus as claimed in claim 1 wherein said transmitter comprises a computer and said set of instructions is contained in a program runnable in the computer, said computer being provided with a loudspeaker capable of emitting said ultrasonic signal at predetermined times during running of the program.

6. The apparatus as claimed in claim 5 wherein the program when running in the computer enables the computer to generate a visual display on a screen, a said ultrasonic signal and a said audio signal.

7. The apparatus as claimed in claim 1 wherein said receiver includes a microphone, a microprocessor decoder and controller and means whereby a said ultrasonic signal received by the microphone may be converted to an electronic signal and sent to the decoder to actuate a said function.

8. The apparatus as claimed in claim 7 wherein each of said preprogrammed functions is switchable between an on-and-off condition in response to a said ultrasonic signal from the transmitter.

9. The apparatus as claimed in claim 7 wherein one or more of the settings of a said pre-programmed function is variable in response to a said ultrasonic signal from the transmitter.

10. The apparatus as claimed in claim 7 wherein said functions comprise audio and/or visual and/or motion functions.

11. The apparatus as claimed in claim 7 wherein each said ultrasonic signal comprises a series of width modulated tone bursts.

12. The apparatus as claimed in claim 1 wherein said transmitter comprises a computer and said set of instructions is contained in a program runnable in the computer, said computer being provided with a cable capable of transmitting said ultrasonic signal at predetermined times during running of the program.

13. The apparatus as claimed in claim 1 wherein said receiver includes a connection to a cable and controller and means whereby a said ultrasonic signal received by said cable may be converted to an electronic signal and sent to the decoder to actuate a said function.

14. The apparatus as claimed in claim 5 wherein said loudspeaker is further capable of emitting an audio signal.

15. The apparatus of claim 7 wherein said receiver is housed in one of a stuffed toy and a robot.

16. The apparatus of claim 1 wherein said ultrasonic signal generated by said transmitter is transmitted to said receiver by one of a loud speaker capable of emitting said ultrasonic signal and a cable connecting said transmitter to said receiver.
